(19) United States
(12) Patent Application Publication
(10) Pub. No.: US 2008/0257604 A1
(43) Pub. Date: Oct. 23, 2008

(54) Conduit, manufacture thereof and fusion process therefor

(75) Inventors: William F. Becker, Pittsburgh, PA (US); Thomas Marti, Mars, PA (US); Eric Kerner, Cocoa, FL (US); Michael Benvenuti, Tarentum, PA (US); Michael McKanna, Beaver Falls, PA (US); Douglas Urbanek, Tarentum, PA (US)

Correspondence Address: THE WEBB LAW FIRM, P.C., 700 KOPPERS BUILDING, 436 SEVENTH AVENUE, PITTSBURGH, PA, 15219, US

(73) Assignee: UNDERGROUND SOLUTIONS TECHNOLOGIES GROUP, INC., Poway, CA (US)

(21) Appl. No.: 12/102,298

(22) Filed: Apr. 14, 2008

Related U.S. Application Data
(60) Provisional application No. 60/923,298, filed on Apr. 13, 2007.

(51) Int. Cl. E21B 7/04; F16L 13/02

(52) U.S. Cl. 175/62; 285/21.1; 285/41; 285/18; 138/155

(57) ABSTRACT

A method for fusing a first conduit section to a second conduit section, each including at least one bell portion with a first end and a second end and having a bell portion inside dimension greater at the second end of the bell portion than at the first end of the bell portion. The method includes: heating and melting at least a portion of each of the second end of the bell portion of the first conduit section and the second end of the bell portion of the second conduit section; and fusing the first conduit section and the second conduit section by engaging the second end of the bell portion of the first conduit section with the second end of the bell portion of the second conduit section, thereby creating a fused conduit system having a fused joint area.

### CROSS REFERENCE TO RELATED APPLICATIONS

This application claims the benefit of priority of U.S. Provisional Patent Application Ser. No. 60/923,298, filed Apr. 13, 2007, which is herein incorporated by reference in its entirety.

### BACKGROUND OF THE INVENTION

1. Field of the Invention

The present invention relates generally to systems for fusing or joining conduit or piping sections, such as polyvinyl chloride conduit or piping, and in particular, to a fusion process for effectively and permanently joining a first conduit section to a second conduit section, as well as a fused conduit, a fused joint area, and methods of manufacturing a conduit.

2. Description of Related Art

Conduit systems are used in many applications throughout the world in order to transfer or convey material, such as water and other fluids, from location to location for distribution throughout the system. In addition, conduit systems are also utilized as a structural enclosure for communication wiring, power wiring, data wiring, fiber optic cable, etc. Typically, such conduit or piping systems are located underground (as above ground piping would be both unsightly and intrusive). Above ground installations do, however, exist. Further, it should be noted that the terms “conduit” and “pipe” may be used interchangeably herein, and can be used to designate a structure (often tubular) for conveying liquid, housing materials, enclosing wires or other conduit/pipe, etc.

Transporting pipe and conduit to installation sites is often logistically difficult, since only short sections can be effectively delivered. According to known processes and installation techniques, once these short sections of pipe or conduit are delivered to the installation site, these sections must be attached or joined together. Therefore, various joining or connection processes have been developed that, among other things, utilize mechanical joints, embedded wires at or near the ends to produce a fusion joint, resistive heating elements for fusion joining conduit sections together, or solvent welding using chemical bonding to join conduit sections using a traditional bell-and-spigot arrangement. For example, see U.S. Pat. Nos. 6,398,264 to Bryant, III; 6,394,502 to Andersson; 6,156,144 to Lueghamer; 5,921,587 to Lueghamer; 4,684,789 to Eggleston; and 4,642,155 to Ramsey. Polyethylene pipe (PE or HDPE) has been routinely fused for many years using known joining techniques. For example, see U.S. Pat. Nos. 3,002,871 to Tramm et al.; 4,987,018 to Dickinson et al.; 4,963,421 to Dickinson et al.; and 4,780,163 to Haneline, Jr. et al. and U.S. Patent Publication No. 2003/0080552 to Genoni. Accordingly, preexisting fusion equipment is available.

In addition, the fusion of polyvinyl chloride conduit is known and practiced, as described and claimed in U.S. Pat. No. 6,982,051 to St. Onge et al. The assignee and owner of this patent is identical to the assignee and owner of the present invention and application. Further and accordingly, the disclosure and contents of the referenced patent are incorporated herein by reference.

One drawback associated with the prior art is the creation of an internal bead extending from the inner wall of fused pipe. Specifically, due to the heat and pressure required to melt and fuse the conduit, when the terminal ends of two pipe sections are melted and engaged, the engagement pressure results in the creation of a bead at the joint area extending from both the internal wall and external wall of the now-fused pipe. The internal bead encroaches slightly into the internal area of the fused pipe and reduces the internal cross section and path of the conduit. Further, the presence of such an internal bead may interfere with and impact certain objects inserted therein, e.g., communication, power and data wiring, etc. For example, the bead may damage the insulation layer of the wire, which may detrimentally affect the wire signal, or cause short circuits in the line.

Presently, this internal bead may be eliminated in a variety of manners. In one variation, the internal bead is removed with a manual or mechanical tool or arrangement. However, such manual/mechanical removal may result in an incomplete or excessive removal of the bead, and removing the internal bead adds time to the installation process. Still further, in many instances this bead removal step is simply forgotten during the installation process. Further, bead removal may not be possible due to conduit and fitting configuration, e.g., fusing of elbows and similar arrangements. In another variation, as opposed to using fused pipe, certain mechanical arrangements are used to connect pipe segments. For example, hand-hole boxes may be used, but such can lead to additional threaded or clamped “joints” in the conduit, which results in more potential for leakage and separation between joined conduit segments. Still further, using metal attachments to restrain joints normally leads to corrosion and other degradation over a period of time, which again increases maintenance and associated costs. In addition, mechanical and solvent welded joints may not be used in many specialized applications, e.g., trenchless applications, as well as applications that require a high joint strength.

### SUMMARY OF THE INVENTION

It is, therefore, an object of the present invention to provide a fusion process for conduit that overcomes the deficiencies of the prior art. It is another object of the present invention to provide a fusion process for conduit that allows for the onsite connection of multiple lengths of conduit. It is a further object of the present invention to provide a fusion process for conduit that provides a single conduit system with joints of sufficient strength, such that the conduit can be installed by multiple trenchless and open trench methods in long lengths, which also preclude leakage through the joints. It is another object of the present invention to provide a shaped and fusible thermoplastic conduit that may be fused and used without removing the internal bead and without risk to any objects inserted therein, e.g., communication wiring, power wiring, data wiring, etc. It is a still further object of the present invention to provide a method of fusing shaped conduit. It is another object of the present invention to provide a method of manufacturing shaped and fusible conduit.

Accordingly, in one embodiment, provided is a method for fusing a first conduit section to a second conduit section, where each section includes at least one bell portion with a first end and a second end and having a bell portion inside dimension greater at the second end of the bell portion than at the first end of the bell portion. The method includes: heating and melting at least a portion of each of the second end of the bell portion of the first conduit section and the second end of the bell portion of the second conduit section; and fusing the first conduit section and the second conduit section by engaging the second end of the bell portion of the first conduit section with the second end of the bell portion of the second conduit section, thereby creating a fused conduit having a fused joint area.

In a further aspect and embodiment, the present invention is directed to an on-site method of fusing a first conduit section to a second conduit section, each section including a linear portion and at least one bell portion with a first end and a second end and having a bell portion inside dimension greater at the second end of the bell portion than the first end of the bell portion. The method includes: mobilizing at least one fusion apparatus to an on-site location, and the fusion apparatus is adapted to: (i) heat and melt at least a portion of each of the second end of the bell portion of the first conduit section and the second end of the bell portion of the second conduit section; and (ii) fuse the first conduit section and the second conduit section by engaging the second end of the bell portion of the first conduit section with the second end of the bell portion of the second conduit section, thereby creating a fused conduit having a fused joint area.

In a still further embodiment, provided is an on-site method of manufacturing a conduit section. This method includes engaging at least one terminal end of a conduit section with a shaped mandrel, thereby forming a bell portion on the at least one terminal end of the conduit section.

In yet another embodiment, the present invention is directed to a conduit section. This conduit section includes: a conduit body having a first terminal end and a second terminal end; and a bell portion located on at least one of the first terminal end and the second terminal end. Further, the conduit body is manufactured from a thermoplastic material having properties sufficient to permit fusion of the bell portion to a bell portion on a subsequent conduit section.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a side sectional view of one embodiment of a conduit according to the principles of the present invention;

FIG. 2 is a side view of another embodiment of a conduit according to the principles of the present invention;

FIG. 3 is a side view of yet another embodiment of a conduit according to the principles of the present invention;

FIG. 4 is a side sectional view of a fused conduit made in accordance with one embodiment of a method according to the principles of the present invention;

FIG. 5 is a side view of a fused conduit made in accordance with another embodiment of a method according to the principles of the present invention;

FIG. 6 is a side sectional view of a conduit in an intermediate step of manufacture in one embodiment according to the principles of the present invention; and

FIG. 7 is a side sectional view of a conduit in an intermediate step of manufacture in another embodiment according to the principles of the present invention.

### DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

Various numerical ranges are disclosed in this patent application. Because these ranges are continuous, they include every value between the minimum and maximum values. Unless expressly indicated otherwise, the various numerical ranges specified in this application are approximations.

In one aspect of the present invention, and as illustrated in various embodiments in FIGS. 1-5, a conduit 100 is provided. In one preferred and non-limiting embodiment, the conduit 100 is a linearly extending length of conduit 100, both prior to and after the fusion process described hereinafter. However, the presently-invented conduit 100 and method of manufacturing this conduit 100 may be used to provide a variety of different forms, arrangements, shapes, sizes and configurations. For example, the conduit 100 (or sections thereof) may be in the form of a substantially linear length of conduit, an elbow, a curve, a non-linear length of conduit, etc. Accordingly, the present invention is not limited to any specific shape, configuration, geometric form, etc. Further, and as discussed above, the term “conduit” is interchangeable with the term “pipe,” and normally refers to a tubular body with a circular cross section. However, any shape, configuration or geometric cross section is envisioned as within the context and scope of the present application.

In one preferred and non-limiting embodiment, and as best seen in FIG. 1, the conduit 100 includes a linear portion 102 having a linear portion inside diameter 104. In addition, the conduit 100 includes at least one bell portion 106 having a first end 108 and a second end 110. The bell portion 106 has a bell portion inside diameter 112, and the diameter 112 is greater at the second end 110 of the bell portion 106 than at the first end 108 of the bell portion 106. Further, and in one preferred and non-limiting embodiment, the inside diameter 112 at the first end 108 is substantially the same as the inside diameter 104 of the linear portion 102, and gradually increases towards an intermediate portion 109 of the bell portion 106. From this intermediate portion 109 to the second end 110 of the bell portion 106, the inside diameter 112 remains substantially constant, thereby providing a square face at the second end 110 of the bell portion 106. It is this changed inside diameter 112 that provides or forms the “bell” shape of the bell portion 106 of the conduit 100. In addition, when used in connection with a conduit 100 or bell portion 106 that does not include a circular cross section, at least one inside dimension, e.g., the width, at the second end 110 of the bell portion 106 is greater than the same inside dimension, e.g., the width, at the first end 108 of the bell portion 106.

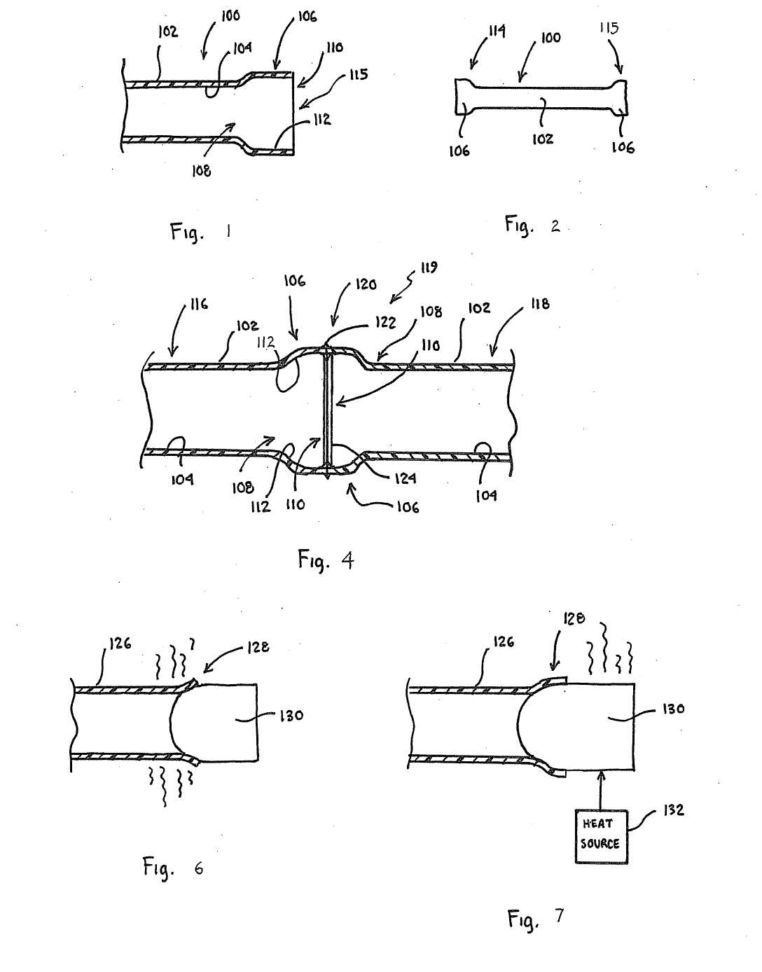

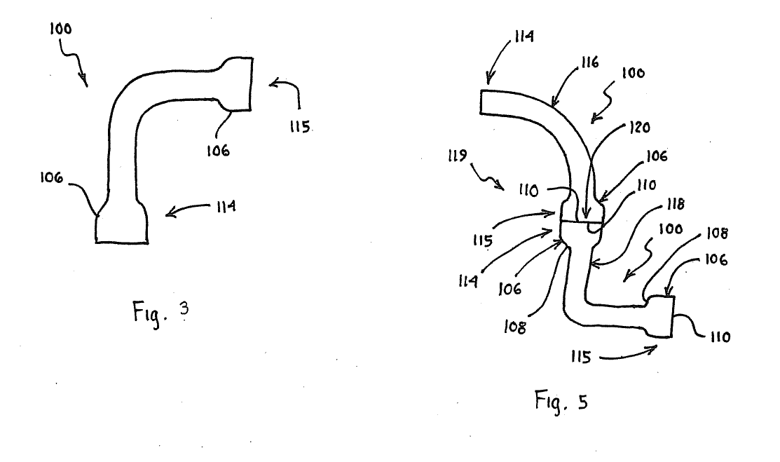

While only illustrated on one end 115 of the conduit 100 in FIG. 1, it is envisioned that the bell portion 106 may be formed, located or positioned on both terminal ends 114, 115 of the conduit 100. Such an arrangement is illustrated in FIG. 2. In addition, by placing the bell portion 106 on each end 114, 115 of the conduit 100, multiple lengths of such conduit 100 may be fused together, as discussed in detail hereinafter. In addition, and as discussed above and illustrated in FIG. 3, any desired shaped or formed conduit 100 may be fused together using the bell portions 106 situated at one or both ends 114, 115 of the conduit 100. For example, the conduit 100 of FIG. 3 is in the form of an elbow with a bell portion 106 located at each terminal end 114, 115.

As discussed above, and in one preferred and non-limiting embodiment, the conduit 100 and/or its components, e.g., the linear portion 102, the bell portion 106, etc., are manufactured from a polyvinyl chloride composition. In particular, the conduit 100 and/or any portion 102, 106 of the conduit 100 may be manufactured by extruding a polyvinyl chloride composition in a known extrusion process. Further, any number of compositions may be used in order to maximize the ability to successfully fuse sections of conduit 100 together, as discussed in more detail hereinafter.

In another aspect, the present invention is directed to a method for fusing a first conduit section 116 to a second conduit section 118. As discussed above, each conduit section 116, 118 includes at least one bell portion 106, and may (but not necessarily) include the linear portion 102. In one preferred and non-limiting embodiment, the first conduit section 116 and the second conduit section 118 are fused as follows. First, the second end 110 of the bell portion 106 of the first conduit section 116 is positioned in an opposing relationship with the second end 110 of the bell portion 106 of the second conduit section 118. Next, the second ends 110 of the bell portions 106 of each conduit section 116, 118 are aligned. At least a portion of the second ends 110 of each of the bell portions 106 of the conduit sections 116, 118 are melted. Further, the melted ends 110 are engaged with each other, and pressure is maintained between the engaged ends 110, thereby creating a fused conduit 119 having a fused joint area 120. In one embodiment, the pressure and engagement of the melted ends 110 is maintained until the melted ends 110 of each conduit section 116, 118 are cooled sufficiently to provide the fused conduit 119 having the fused joint area 120 of a desired strength.

A further example of a fused conduit 119 using the fusion method of the present invention is illustrated in FIG. 5. As seen in this non-limiting embodiment, the first conduit section 116 is in the form or shape of a curve, and the second conduit section 118 is in the form or shape of an elbow. Further, while the second conduit section 118 includes a bell portion 106 on each terminal end 114, 115, the first conduit section 116 has the bell portion 106 located on only the second terminal end 115. Fusion of the first terminal end 114 (non-bell portion end) of the first conduit section 116 to a subsequent length, piece or section of conduit or pipe without a bell portion 106 located thereon may be accomplished according to the fusion process and method shown and described in U.S. Pat. No. 6,982,051.

As discussed above, and in one preferred and non-limiting embodiment, the first conduit section 116, the second conduit section 118, the linear portion 102 of the first conduit section 116, the linear portion 102 of the second conduit section 118, the bell portion 106 of the first conduit section 116 and/or the bell portion 106 of the second conduit section 118 may be manufactured from a polyvinyl chloride composition. However, the first conduit section 116 and the second conduit section 118 may be extruded from a variety of thermoplastic materials, e.g., plastic, polyethylene, high density polyethylene, etc, where the thermoplastic material exhibits or includes properties sufficient to permit fusion of the bell portion 106 of the first conduit section 116 to the bell portion 106 of the second conduit section 118. Therefore, and as discussed above in connection with FIGS. 1-5, one or both of the first conduit section 116 and the second conduit section 118 includes a bell portion 106 positioned or formed on one or both ends 114, 115 of the conduit section 116, 118.

In order to fuse additional lengths of conduit, the process may be used with subsequent sections of conduit 100 having the bell portion 106 on at least one terminal end 114, 115. Specifically, the positioning, aligning, melting and engaging steps discussed above can be used to continue adding subsequent lengths or sections of conduit 100 (regardless of shape or size), thereby creating a longer, fused conduit system 119. It should be noted, however, that the fusion process described above only necessarily requires the melting and engaging step in order to provide the fused conduit system 119 and the fused joint area 120. Further, since these conduit sections 116, 118 may be formed in a variety of shapes, sizes, forms, configurations, etc, and when fused together at the second end 110 of the respective bell portion 106 of each conduit section 116, 118 (and further or subsequent conduits 100), a fused conduit system 119 is provided. This fused conduit system 119 can be used to create any desired length conduit, casing, pipeline or other above ground or underground system.

In one preferred and non-limiting embodiment, the second end 110 of one or both of the bell portions 106 may be faced prior to the alignment step. Specifically, using a facing mechanism (as described in U.S. Pat. No. 6,982,051), and prior to melting and engaging the second ends 110 of the bell portions 106, provides parallel, smooth, flush and opposing edges. In particular, the facing mechanism (i.e., the facing blade or implement) grinds or faces the ends 110 until a minimal distance exists between faced ends 110 (normally the thickness of the facing blade or implement), or it reaches predetermined stops associated with the devices clamping or holding these ends 110.

Still further, and as discussed above in connection with the fusion of two opposing conduit sections 116, 118, the melting step of the present embodiment may include the simultaneous heating of both the second end 110 of the bell portion 106 of the first conduit 116 and the second end 110 of the bell portion 106 of the second conduit 118. In order to provide appropriate heating and melting of the second ends 110, multiple heat zones can be provided and applied to the second ends 110 of the bell portions 106 of the conduits 116, 118. In particular, heating plates (as described in U.S. Pat. No. 6,982,051) may be used to provide such zone heating, e.g., variance in temperature of various portions of the heating surface, for example, the upper and lower surface. This provides a more uniform melting of the ends 110, due to the natural physics of the heating process.

After the conduits 116, 118, and in particular the bell portions 106 of the conduits 116, 118, are fused, an outer bead 122 and inner bead 124 are formed. Again, such beads 122, 124 are formed since the second end 110 of the bell portion 106 of each conduit 116, 118 is heated and at least partially melted. Upon engaging and pressing the ends 110 together, the melted material is pressed and forms these beads 122, 124. See, e.g., FIG. 4. It is the potentially detrimental effects of these formed beads 122, 124 that the above-described conduit 100, 116, 118, 119 and fusion method minimize or obviate, with particular usefulness in connection with conduit used to house wiring, cables, etc.

In another preferred and non-limiting embodiment, sufficient pressure is maintained and subsequent cooling permitted at the second ends 110 of the bell portions 106 of each conduit section 116, 118 to form a fused joint area 120 of a desired strength. In addition, and in order to provide a fused joint area 120 exhibiting at least 50% of the tensile strength (or even substantially the same strength) as one or both of the conduit sections 116, 118, any of the following parameters may be selected and used during the fusion process: engagement interfacial pressure, engagement gauge pressure, engagement time, heating interfacial pressure, heating gauge pressure, heating temperature and/or heating time. For example, in one embodiment, the engagement gauge pressure is calculated using the following formula:

$$MGp = \frac{\frac{π ( {OD}^{2} - {ID}^{2} )}{4} \times Ip}{Ca}$$

where MGp is machine gauge pressure, π is 3.1416 circle formula, OD² is outside diameter in inches squared, ID² is inside diameter of the linear portion in inches squared, Ip is interfacial pressure, and Ca is the cylinder area of machine in square inches. Further, the “OD” and “ID” referenced are either: the outside and inside diameter for the conduit or pipe without the bell portion 106; or those of the bell portion 106, itself. As the cross sectional area will preferably be the same for each, either sets of diameters can be used. In addition, if the bell portion 106 includes a different cross section, e.g., a square shape, this formula may be modified by substituting “cross sectional area of the end of the bell portion” for the fraction included in the numerator of the fraction. In another embodiment, the engagement interfacial pressure is between about 50 psi and about 250 psi, the heating pressure is between about 5 psi and about 50 psi, and the time period between the heating and melting and the engaging is up to about 10 seconds.

By using the above-discussed polyvinyl chloride composition, as well as the bell portions 106 of the conduit 100, a fused conduit system 119 and fused joint area 120 are created. Due to the shape of the fused bell portions 106, the inner bead 124 that is formed during the fusion process does not encroach into the area defined by the linear portion inside diameter 104 (or the “non-bell” portions of the conduit 100). Other dimensions may be modified and maximized for effective use, e.g., general flow characteristics, intended use of the fused conduit 119, etc. Such dimensions, e.g., the length of the bell portion 106 and the offset from the linear portion 102 of the conduit 100, may be set to keep the inner bead 124 out of the area defined by the linear portion inside diameter 104, as well as to minimize the overall, fused bell portion 106 length. In particular, by minimizing the overall bell portion 106 length, the ability of wire or fiber optic cable to sag into the bell portion 106 (thereby jeopardizing the integrity of any protective coating on the wire or cable by touching or rubbing against the inner bead 124) is minimized or eliminated. Still further, the length of the bell portion 106 and the offset may also be varied for effective utilization and implementation in certain specialized or necessary applications.

As discussed, and in one preferred and non-limiting embodiment, the conduit 100, 116, 118 (or any part thereof) may be manufactured using a polyvinyl chloride composition. According to this embodiment, and as illustrated in FIG. 6, in manufacturing the conduit 100, a linear section 126 of conduit is provided, and this linear section 126 includes at least one terminal end 128. It should be noted that this linear section 126 may be at the terminal end 128 of any size, shape or configuration of conduit 100, e.g., an elongated, linear length, an elbow, a curve, etc. Next, the terminal end 128 is engaged with a shaped mandrel 130, which bears against the terminal end 128 and deforms the linear section 126, thereby forming the above-discussed bell portion 106 at the terminal end 128 of the linear section 126. Accordingly, the mandrel 130 is sized and shaped so as to impart the appropriate form, contour, shape and size of the desired bell portion 106 to the linear section 126 of the conduit 100.

The present invention contemplates various ways of forming the bell portion 106. In one preferred and non-limiting embodiment, and as illustrated in FIG. 6, prior to engaging the terminal end 128 against the shaped mandrel 130, the terminal end 128 is heated. Specifically, the terminal end 128 is heated to a temperature sufficient to allow the end 128 to form and take the shape of the shaped mandrel 130. For example, the terminal end 128 may already be at or near a sufficient temperature after extrusion, such that the formation of the bell portion 106 may occur during, or immediately after, the extrusion process and before cooling. In another preferred and non-limiting embodiment, and as opposed to heating the terminal end 128 of the linear section 126, the shaped mandrel 130 is heated to a temperature appropriate to at least partially melt the terminal end 128 of the conduit 100. Such an arrangement is illustrated in FIG. 7. In order to allow the shaped mandrel 130 to achieve the desired melting temperature, an appropriate heat source 132 may be provided. Of course, this heat source 132 may be controlled to a specified temperature range in order to maximize the efficiency and effectiveness of the heating process.

After the bell portion 106 is formed at the terminal end 128 of the conduit 100, this newly-formed bell portion 106 is permitted to cool. Finally, after the bell portion 106 has cooled and cured, it is disengaged from the shaped mandrel 130. This same manufacturing technique and process may be used on each terminal end 128 of the linear section 126, as needed. In this manner, the conduit 100 is formed with a bell portion 106 on one or both of the terminal ends 128.

While specific methods for manufacturing the inventive conduit 100 have been discussed, any manner of positioning or forming the bell portion 106 on the conduit 100 is envisioned. For example, as opposed to using the shaped mandrel 130, shaped sleeves, forms, molds and other arrangements may be used. For example, the bell portion 106 may be formed on the conduit 100 during the initial extrusion or molding process, or in a variety of methods known in the art for preparing and manufacturing shaped plastic products.

In another preferred and non-limiting embodiment, the bell portion 106 is formed on-site or in the field using transportable and/or portable (mobile) equipment. For example, a fusion apparatus, such as the apparatus described in U.S. Pat. No. 6,982,051 can be modified for use in forming the bell portion 106 on a linear length of extruded conduit 100. In addition, the shaped mandrel 130, e.g., in the form of a modified heater mechanism, heat plate, etc., may be used on or in connection with this fusion apparatus. Accordingly, the bell portion 106 can be formed on one or both ends of the conduit 100 on an “as-needed” basis in the field.

The present invention is useful in connection with a variety of applications in both underground and above ground installations. For example, the conduit 100, fused conduit system 119 and method of fusing of the present invention may be used in situations where, according to the prior art and in order to transport and insert a liner conduit within the host conduit, the liner conduit must be manufactured in sections or portions, which are typically much shorter in length than the final and intended liner conduit length. In particular, the conduit sections 116, 118 may be fused at the installation site according to the changing needs and requirements of the lining process. Still further, the conduit 100, fused conduit system 119 and method of fusing of the present invention may be utilized in sliplining applications, wherein a slightly smaller diameter fused conduit is inserted into a larger pipe that is in need of rehabilitation or that is used for conveying or carrying other materials. Another variation of the slipline process for conduit entails the pulling of multiple conduits simultaneously in a “bundle” that result in multiple conduits within a casing or host pipe.

The conduit 100 and fused conduit system 119 may be implemented in various other applications, wherein the fused joint is used in connection with a horizontal directional drilling process. According to this process, a pilot hole is drilled in the ground and can be steered in a precise manner to control elevation and alignment. After the pilot hole is complete, the drill hole is reamed to a larger diameter and filled with drill mud to hold the larger hole open and provide lubrication. The conduit 100, fused conduit system 119 or bundled conduit is then pulled through the drill mud resulting in a conduit or conduit bundle in place.

Further, the fused conduit system 119 is useful in a pipe bursting application. Pipe bursting uses a cutter head, e.g., a large hydraulic or pneumatic cutter head, to break apart old pipe and force the pieces into the surrounding soil. This allows a new pipe or pipe bundles of equal or larger diameter to be pulled into the resultant void. This process is often used where the new line capacity must be increased. Also, the conduit 100 and fused conduit system 119 is equally useful in a direct-bury application, where an at least partially open conduit hole is created, and the fused conduit system 119 inserted or positioned in the conduit hole. Another variation of a direct-bury application entails the use of a plow to cut a slit and pipe opening in the ground, and the conduit 100 or fused conduit system 119 is pulled in behind. This is typically a simultaneous process. The conduit 100, fused conduit system 119, and method of fusing of the present invention can be effectively implemented and used in any number of applications and installations, and all such applications and installations should be considered within the context and scope of the present invention.

In this manner, this aspect of the present invention eliminates the potential impact of the inner bead 124 formed during the fusion process. In addition, this impact is minimized and eliminated without adding additional process steps, costs or time to the fusion and installation process. In this manner, any fusion process that occurs at the work site is not altered, and the overall length of time to engage in the process is not lengthened. In addition, this aspect of the present invention removes the need for any de-beading equipment, and the fused conduit system 119 and fused joint area 120 do not exhibit the above-discussed drawbacks associated with mechanical or solvent welded joints.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A method for fusing a first conduit section to a second conduit section, each comprising at least one bell portion with a first end and a second end and having a bell portion inside dimension greater at the second end of the bell portion than at the first end of the bell portion, the method comprising:
heating and melting at least a portion of each of the second end of the bell portion of the first conduit section and the second end of the bell portion of the second conduit section; and
fusing the first conduit section and the second conduit section by engaging the second end of the bell portion of the first conduit section with the second end of the bell portion of the second conduit section, thereby creating a fused conduit system having a fused joint area.

2. The method of claim 1, further comprising maintaining pressure between the engaged second end of the bell portion of the first conduit section and the second end of the bell portion of the second conduit section until the melted ends of each conduit section are cooled sufficiently to provide a fused joint area of a desired strength.

3. The method of claim 1, wherein, prior to the heating and melting, the method further comprises aligning the second end of the bell portion of the first conduit section with the second end of the bell portion of the second conduit section.

4. The method of claim 1, wherein at least one of the following: the first conduit section, the second conduit section, the bell portion of the first conduit section, the bell portion of the second conduit section or any combination thereof, are manufactured from at least one of the following: polyvinyl chloride composition, a thermoplastic material, polyethylene, high density polyethylene or any combination thereof.

5. The method of claim 1, wherein the first conduit section comprises a bell portion positioned on each end of the first conduit section.

6. The method of claim 5, further comprising the steps of:
heating and melting at least a portion of each of a second end of an un-fused bell portion of the first conduit section and a second end of a bell portion of a subsequent conduit section; and
fusing the second end of the un-fused bell portion of the first conduit section and the second end of a bell portion of the subsequent conduit section by engaging the second end of the un-fused bell portion of the first conduit section with the second end of the bell portion of the subsequent conduit section portion, thereby creating a subsequent fused joint area.

7. The method of claim 1, further comprising facing at least one of the second end of the bell portion of the first conduit section and the second conduit section prior to the heating and melting step.

8. The method of claim 1, wherein the heating and melting step includes the simultaneous heating of both the second end of the bell portion of the first conduit section and the second end of the bell portion of the second conduit section.

9. The method of claim 1, further comprising applying a plurality of heat zones to at least a portion of at least one of the second end of the bell portion of the first conduit section and the second end of the bell portion of the second conduit section.

10. The method of claim 9, wherein at least one of the plurality of heat zones is configured to exhibit a different temperature than at least one other heat zone.

11. The method of claim 1, further comprising selecting at least one of the following: engagement interfacial pressure, engagement gauge pressure, engagement time, heating interfacial pressure, heating gauge pressure, heating temperature, heating time or any combination thereof, such that the fused joint area exhibits at least 50% of the tensile strength of at least one of the first conduit section and the second conduit section.

12. The method of claim 11, wherein the engagement gauge pressure is calculated utilizing the following formula:
$$MGp = \frac{\frac{π ( {OD}^{2} - {ID}^{2} )}{4} \times Ip}{Ca}$$
wherein MGp is machine gauge pressure, π is 3.1416 circle formula, OD² is outside diameter in inches squared, ID² is inside diameter of the linear portion in inches squared, Ip is interfacial pressure, and Ca is the cylinder area of machine in square inches, and wherein the OD and ID set used is at least one of the following: the OD and ID of at least one of the first conduit section and second conduit section; the OD and ID of the bell portion; and wherein, if the cross sectional area of the second end of the bell portion is not circular, substituting “cross sectional area of the second end of the bell portion” for the fraction included in the numerator of the fraction.

13. The method of claim 11, wherein the engagement interfacial pressure is between about 50 psi and about 250 psi.

14. The method of claim 11, wherein the heating interfacial pressure is between about 5 psi and about 50 psi.

15. The method of claim 1, wherein the time period between the heating and melting and the engaging is up to about 10 seconds.

16. A fused joint area made in accordance with claim 1.

17. A fused conduit system made in accordance with claim 1.

18. A horizontal directional drilling method, comprising:
drilling a pilot hole in the ground;
reaming the pilot hole to an appropriate diameter; and
inserting the fused conduit or bundle of fused conduits made in accordance with claim 1 into the pilot hole.

19. An underground conduit installation method, comprising:
creating an at least partially open conduit hole; and
inserting the fused conduit or bundle of fused conduits made in accordance with claim 1 into the conduit hole.

20. A method of lining a host conduit, comprising inserting the fused conduit or bundle of fused conduits made in accordance with claim 1 into the host conduit.

21. The method of claim 1, wherein at least one of the following: the first conduit section, the second conduit section, the fused conduit or any combination thereof is in the form of at least one of the following: a substantially linear length of conduit, an elbow, a curve, a non-linear length of conduit or any combination thereof.

22. An on-site method of fusing a first conduit section to a second conduit section, each comprising a bell portion inside dimension greater at the second end of the bell portion than at the first end of the bell portion, the method comprising: mobilizing at least one fusion apparatus to an on-site location, the fusion apparatus configured to: (i) heat and melt at least a portion of each of the second end of the bell portion of the first conduit section and the second end of the bell portion of the second conduit section; and (ii) fuse the first conduit section and the second conduit section by engaging the second end of the bell portion of the first conduit section with the second end of the bell portion of the second conduit section, thereby creating a fused conduit system having a fused joint area.

23. An on-site method of manufacturing a conduit section, comprising engaging at least one terminal end of a conduit section with a shaped mandrel, thereby forming a bell portion on the at least one terminal end of the conduit section.

24. The method of claim 23, further comprising forming a bell portion on a plurality of terminal ends of the conduit section.

25. A conduit section made in accordance with claim 23.

26. A conduit section, comprising:
a conduit body having a first terminal end and a second terminal end; and
a bell portion located on at least one of the first terminal end and the second terminal end;
wherein the conduit body is manufactured from a thermoplastic material having properties sufficient to permit fusion of the bell portion to a bell portion of a subsequent conduit section.

27. A fused conduit system, comprising a plurality of conduit bodies of claim 26, and fused together at least one terminal end thereof.

28. The conduit section of claim 26, wherein the conduit section is in the form of at least one of the following: a substantially linear length of conduit, an elbow, a curve, a non-linear length of conduit or any combination thereof.
